(19) United States
(12) Patent Application Publication
(10) Pub. No.: US 2010/0274906 A1
(43) Pub. Date: Oct. 28, 2010

(54) System for Activating and Deactivating a Function

(75) Inventors: Peter Fuks, Jarfalla (SE); Gunnar Larsson, Taby (SE)

Correspondence Address: POTOMAC PATENT GROUP PLLC, P. O. BOX 270, FREDERICKSBURG, VA, 22404, US

(73) Assignee: MAGNUS GRANHED, Lidingö (SE)

(21) Appl. No.: 12/747,311

(22) PCT Filed: Dec. 8, 2008
(86) PCT No.: PCT/SE2008/000690

§ 371 Date: Jun. 10, 2010

(30) Foreign Application Priority Data
Dec. 11, 2007 (SE) 0702782-4
Jan. 21, 2008 (SE) 0800135-6

(51) Int. Cl. G06F 3/033; G06F 15/16

(52) U.S. Cl. 709/227; 345/163; 345/166

(57) ABSTRACT

The present invention relates to a system being adapted to be connected to at least one computer. The system comprises: at least one tracking surface, and a pointing device adapted to navigate on the at least one computer when the pointing device is moved across the at least one tracking surface, which defines a first zone and a second zone. The system further comprises a detection unit which detects the zone the pointing device is present in, and a control unit adapted to activate a function when present in the first zone.

### TECHNICAL FIELD

The present invention relates to a system for activating and deactivating a function in relation to a computer, preferably to control access to an internal or external network via Internet.

### BACKGROUND

Internet has become a very important information channel for many people and companies and access to Internet is based on the fact that a user computer is connected to Internet through a network card and a modem. Undesired programs (Trojans etc.) are spread to users via different home pages and e-mails by persons that are interested to get access to information that is stored on user computers. This can be to some degree prevented by most anti virus programs, but there is still a risk as long as the computer is connected to Internet.

It is therefore desired to prevent others to have access to a computer through Internet by prohibiting access when the user is not using the computer or not using internet related software. A solution is described in the European patent application EP 1 502 171 in which user activity is monitored and Internet access denied if the user has not been active for a predetermined time period. The monitoring is performed continuously and the deactivation/activation of Internet access is automatic.

A drawback with the prior art solution is that a stand alone monitor device, that monitor user activity, needs to receive information from all types of input/output devices that the user wants to monitor, which makes the monitor device complex and expensive to manufacture.

### SUMMARY OF THE INVENTION

An object with the present invention is to provide a system that will assist the user of a computer to activate/deactivate a function, such as Internet access, being less complex than the prior art solutions.

This object is achieved by a system being adapted to be connected to at least one computer provided with a pointing device. The system comprises at least one tracking surface, whereby said pointing device is adapted to navigate on the at least one computer when the pointing device is moved across the at least one tracking surface. The at least one tracking surface defines a first zone and a second zone, and the system further comprises a detection unit which detects the zone the pointing device is present in, and a control unit adapted to activate a function when present in the first zone.

In a further embodiment, the control unit is adapted to deactivate the function when present in the second zone.

In yet another embodiment, the control unit is further adapted to control the switching state, i.e. also adapted to deactivate the function such as to change the state of the function (activate/deactivate), when present in the first zone, and to maintain the state of the function when present in the second zone. An indicator is preferably provided to indicate the state of the function, i.e. on/off.

An advantage with the present invention is that the system is very easy to install to a standard computer since no modification in the hardware of the computer or installation and configuration/updating of software is necessary.

Another advantage is that the function is operating system and architecture independent which makes it suitable for any computer.

Further objects and advantages may be found by a skilled person in the art from the detailed description.

### BRIEF DESCRIPTION OF DRAWINGS

The invention will be described in connection with the following drawings that are provided as non-limited examples, in which:

FIG. 1 shows a computer system with a first embodiment of a control system according to the present invention.

FIG. 2 shows a computer system with a second embodiment of a control system according to the present invention.

FIG. 3a shows a perspective view of a third embodiment of a control system according to the present invention.

FIG. 3b shows a top view of a first implementation of the detector plane of the control system in FIG. 3a.

FIG. 3c shows a top view of a second implementation of the detector plane of the control system in FIG. 3a.

FIG. 3d shows a top view of a third implementation of the detector plane of the control system in FIG. 3a.

FIG. 4 shows a computer system with a fourth embodiment of a control system according to the present invention.

FIG. 5 shows a block diagram of a control system according to the present invention.

FIG. 6 shows a computer system with a fifth embodiment of a control system according to the present invention.

FIG. 7 shows a computer system of FIG. 1 wherein the first embodiment of the control system is replaced with a sixth embodiment of a control system according to the present invention.

FIG. 8 shows a seventh embodiment of a control system according to the present invention.

### DETAILED DESCRIPTION

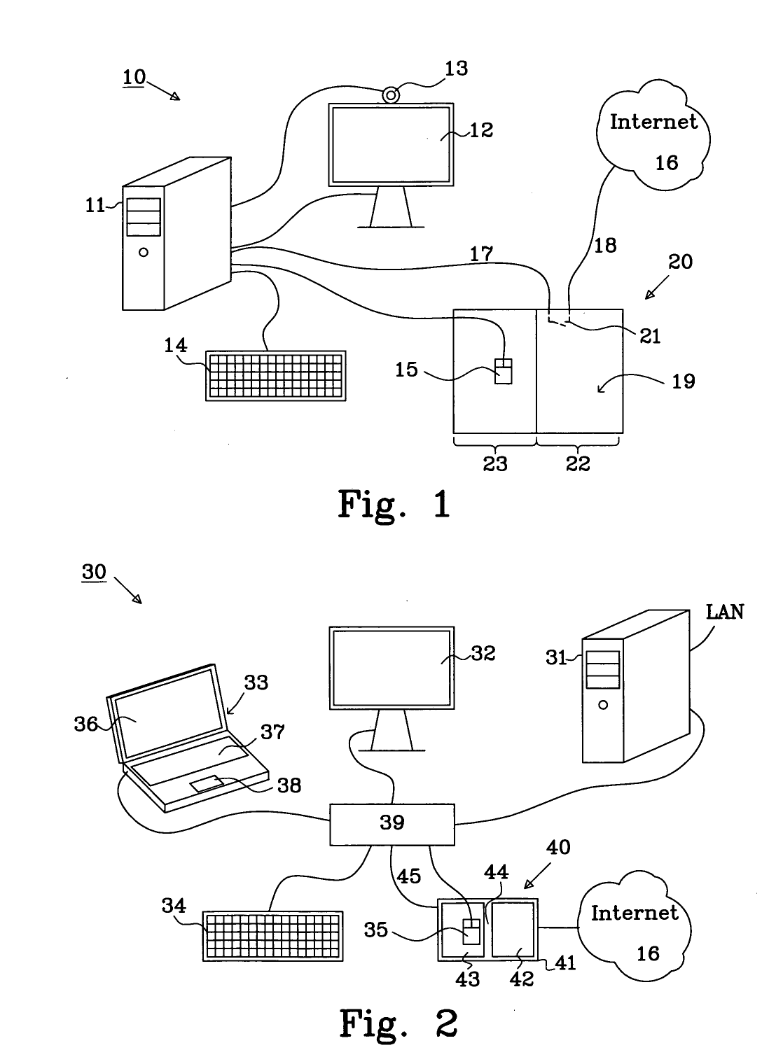

FIG. 1 shows a computer system 10 comprising a computer 11, a computer display 12 with a web camera 13, a keyboard 14, and a pointing device 15, i.e. a computer mouse, adapted to navigate on the computer when the pointing device is moved across a tracking surface 19. A first embodiment of a control system 20 is, in this embodiment designed as a mouse pad, provided with connectors in order to be connected between the network card of the computer 11 and the Internet 16 through cables 17 and 18. Access to the Internet is controlled by the control system 20 comprising an internal switch 21 which state is determined by the position of the pointing device 15 on the tracking surface 19 of the control system 20. The tracking surface 19 is in this embodiment divided into two zones, a first zone 22 and a second zone 23. The zones may be marked with different colours, e.g. red/green, or be divided by a line, as illustrated in the figure, to make the user aware of the different zones. The internal switch 21 is preferably a semi-conductor device included in an integrated circuit.

A detection unit (not shown) and a control unit (not shown) are embedded in the control system 20. The detection unit detects which zone the pointing device 15 (mouse) is present in, and the control unit is configured to activate a function, which in this embodiment is to open access to Internet, when the pointing device is present in the first zone 22, and to deactivate the function when the pointing device is in the second zone 23. The activation is preferably instantaneous, and the deactivation may be immediate but is preferably delayed a preselected period of time to avoid unintentional deactivation by moving the pointing device outside the first zone for a short period of time.

The control unit may further be configured to establish a communication link, preferably a secure communication link, to an external network, such as a restricted network of a company.

FIG. 2 shows a computer system 30 comprising a stationary computer 31, a computer display 32, a keyboard 34, a pointing device 35 (in this embodiment a computer mouse), and a portable computer 33 being provided with its own display 36, keyboard 37 and pointing device 38 (touch pad). The stationary computer 31, the computer display 32, the portable computer 33, the keyboard 34 and the pointing device 35 are connected to a switch 39. One function of the switch 39 is to alternate which computer (stationary or portable) that is controlled by the pointing device. Another function is to alternate which computer is connected to the computer display 32, and also which computer is connected to the keyboard 34.

As an example, the stationary computer 31 is connected to the computer display 32, the keyboard 34 and the pointing device 35 (similar to FIG. 1) in a first switching state, and the portable computer 33 is connected to the computer display 32, the keyboard 34 and the pointing device 35 in a second switching state. The user of the portable computer will have access to a full size keyboard, a normal mouse as a pointing device, and a larger computer display when the switch is in the second switching state.

The switching state is controlled by a detection unit (not shown) in a control system 40 according to a second embodiment of the invention. The control system 40 comprises a surface 41 having two separate tracking surfaces, a first tracking surface 42 defining a first zone and a second tracking surface 43 defining a second zone. A non-active zone 44 is present between the first and second zones. The control system is connected to the switch 39 through a cable 45 and a control unit (not shown) send out a signal indicative of the switching states dependent on the position of the pointing device, which is detected by the detection unit. It is preferred that an active detection needs to be made, i.e. it must be determined if the pointing device is present in any of the first zone 42 and second zone 43. If no detection is made, it is assumed that the pointing device is outside both the first and the second zone, and the computer display indicates that no computer input is available. The active detection of the pointing device may provide a higher degree of certainty in determining in which zone the pointing device is present.

It is also possible to combine the alternating function described above with access to Internet 16. The control system 40 is in this alternative embodiment connected to Internet 16 and the cable 45 between the switch 39 and the control system 40 also include a connection to the network card of the selected computer, i.e. the network card of the stationary computer 31 is connected to the control system 40 through cable 45 if the pointing device is present in the first zone 42, and the network card of the portable computer 33 is connected to the control system 40 through cable 45 if the pointing device is present in the second zone 43. If the pointing device is not determined to be present in the first or the second zone, Internet access is denied.

In a preferred embodiment, the stationary computer 31 is part of an internal network (indicated with LAN) and should not be connected to Internet, and the portable computer 33 is only intended to be used for e-mail and other

Internet dependent services (no connection to the internal network). The control system 40 will in this example include an internal switch (not shown) that only will provide access to Internet when the pointing device 35 is present in the second zone 43. The control system 40 will provide a separation between the internal network and Internet.

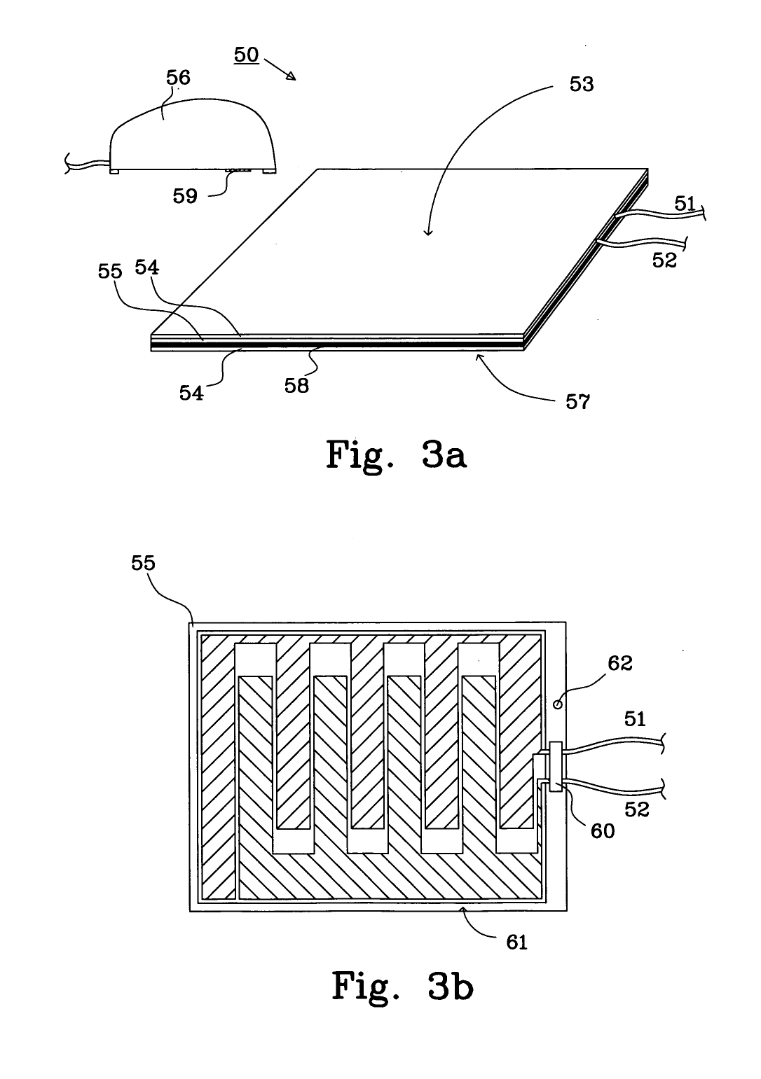

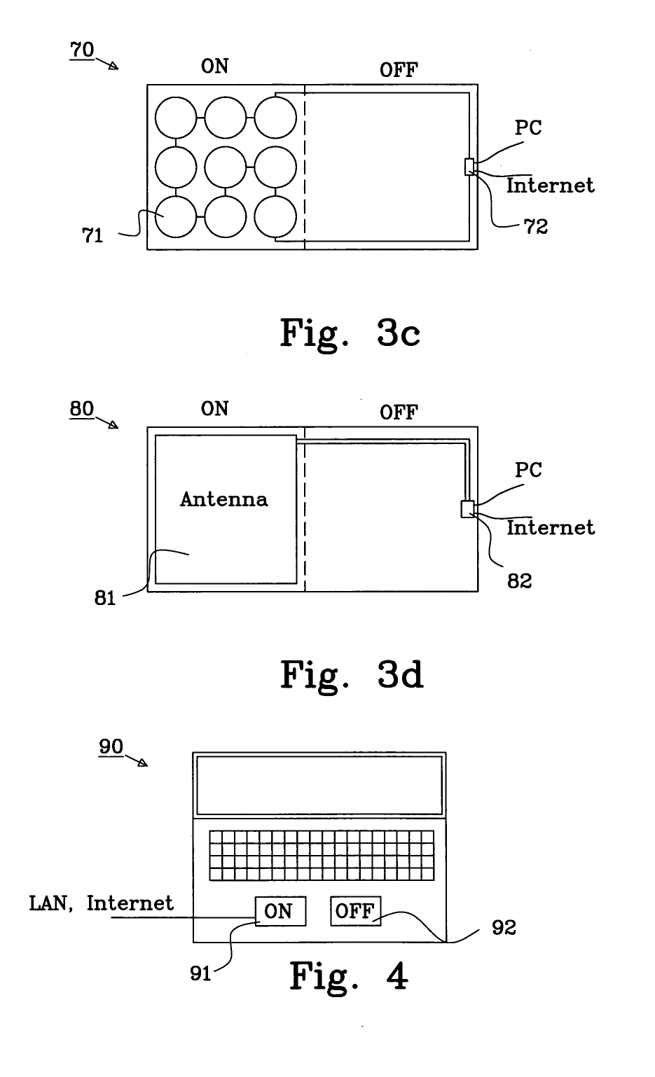

FIG. 3a shows a perspective view of a third embodiment of a control system 50 according to the present invention and FIG. 3b shows a top view of the detector plane present in FIG. 3a. The control system 50 is adapted to be connected to a computer (not shown) through a cable 51 and to Internet through cable 52. A first tracking surface defines a first zone 53 at the top surface of the control system 50, which comprises a protective layer 54 and a detector plane 55. A pointing device 56, such as a computer mouse, is used to navigate on the computer together with the first tracking surface. The pointing device is in this embodiment provided with a conductive object 59, such as a metal foil, which a detection layer 61 may detect if the pointing device is using the first tracking surface to navigate on the computer. The control system 50 further comprises a second tracking surface defining a second zone 57 arranged on a reverse side of the first tracking surface, and a ground plane 58 arranged between the first zone 53 and the second zone 57 to prevent unintentional detection of the conductive object 59 by the detection layer 61. The second zone 57 comprises also a protective layer 54 which is used to navigate on the computer together with the pointing device 56 when the control system 50 is turned up side down.

FIG. 3b shows a top view of a first implementation of the detector plane 55 of the control system 50 as shown in FIG. 3a. A cable 51, arranged to be connected to a computer, and a cable 52, arranged to be connected to Internet, are connected to a control unit 60. A detector unit comprises in this embodiment the detection layer 61 based on capacitive detection comprising conductive patches, or interleaved conductive strips. The conductive object, attached to the pointing device, will affect the capacitance of the detection layer and detect that the first zone is used for navigation. The control unit 60 will then indicate that Internet access is available by a LED 62 and activates the Internet connection to the computer.

It is also possible to include additional logic in the control unit 60, which will allow the user to access certain web pages, e.g. Internet pages for making bank payments, or restricted networks, whereby a control system 50 may be connected to a user (and possibly the Internet address of the user) to prevent other unauthorised users to obtain access.

FIG. 3c shows a top view of a second implementation of the detector plane 70 of the control system 50 as shown in FIG. 3a. The detection unit is in this implementation based on inductive detection, and comprises a plurality of interconnected inductors 71, wherein the first and last inductor is connected to a control unit 72. The inductors are preferably balanced and are affected when a conductive object, such as the metal foil 59 is moved across the surface.

FIG. 3d shows a top view of a third implementation of the detector plane 80 of the control system 50 as shown in FIG. 3a. The detection unit comprises in this implementation an antenna layer 81, arranged on one tracking surface, being connected to a control unit 82. The antenna layer 81 is configured to detect an electromagnetic radiation emitted from the pointing device. The antenna layer 81 may also be configured to detect the changes in the electromagnetic field from the antenna by the presence of the pointing device.

FIG. 4 shows a computer system with a fourth embodiment of the present invention implemented in a portable computer 90. The portable computer is provided with two separate pointing sensitive devices, such as touch pads, for navigating on the computer. A first touch pad 91 provides a network connection to the computer, and the second touch pad 92 is preferably used when external access is not desired. A wireless connection may be activated when the computer detects that the first touch pad 91 is used, and the detection is preferably pressure or capacitive implemented. The network connection could be LAN, WLAN, Internet access, etc. It is possible to provide the portable computer with only one touch pad, which is divided into two zones similar to the embodiment described in connection with FIG. 1.

FIG. 5 shows a block diagram of a control system 100 according to the present invention. A first sensor 101 is connected to a detection unit 102. An optional second sensor 103, which is used to determine if the pointing device is present in the second zone (as described in connection with FIG. 2) is also connected to the detection unit 102. The first sensor and the detection unit 102 could be integrated when the second sensor is omitted (as described in connection with FIGS. 3a-3d). A control unit 104 is connected to the detection unit 102 and controls the switching state of a switch 105. Electrical power is preferably provided through a separate USB cable 109, or through the network cable 107 provided power over Ethernet is available. Optionally an internal power source 106 could be provided in the control system 100. A network cable 108 is also connected to the switch.

The cables 107 and 108 could also be replaced by wireless communication, in order to limit the number of cables attached to the control system. In this case the power source is preferable internal. Each cable will then be replaced by a wireless communication device.

The control system 100 may also be provided with a GSM-module 110, which receives instructions over the GSM network. The GSM-module 110 is configured to actively activate/deactivate the switch. This is particularly useful if the IT-department in a centrally controlled update of the software on the computer is needed, a back-up of the all computers needs t be performed, or if a user wants to access the computer from home.

The tracking surface may be arranged on top of the detection layer, as illustrated in connection with FIGS. 1, 2 and 3a. The tracking surface may also be provided with an integrated detection layer, as illustrated in connection with FIG. 4, in which each touch pad will indicate the position and also the touch pad used.

The detection unit may be based on pressure detection, electromagnetic detection, optical detection, or ultrasound detection of the pointing device. Pressure detection is illustrated in connection with FIG. 4 and electromagnetic detection is illustrated in connection with FIG. 3d.

Ultrasound detection may be achieved when a tracking surface is provided with an ultrasound waveguide across the tracking surface. The closeness of a pointing device will affect the ultrasound waveguide and the switching state may be altered.

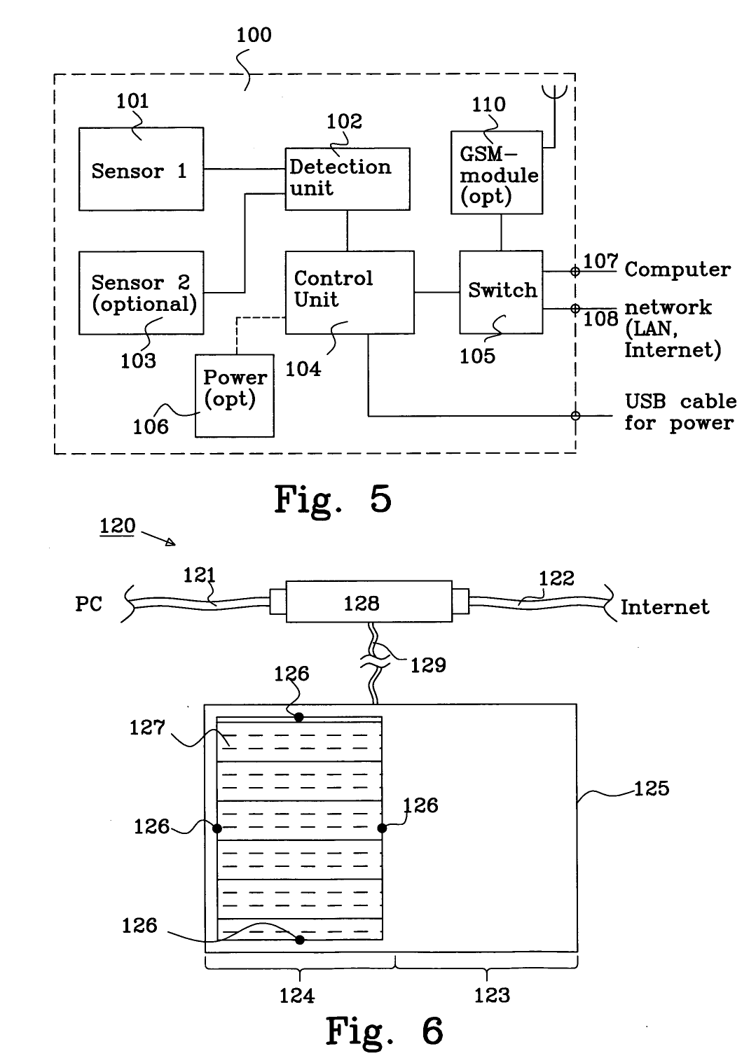

Optical detection may be used when a light source is provided in the pointing device, such as an optical mouse. FIG. 6 discloses a fifth embodiment of a control system 120 according to the present invention. The control system 120 is adapted to be connected to a computer (not shown) through a cable 121 and to Internet through cable 122. A tracking surface is provided on a mouse pad 125 and is divided into a first zone 123 and a second zone 124. An optical mouse (not shown) is used to navigate on the computer when moved across the tracking surface. The optical mouse emits light, normally of a specific wavelength, which a detector unit may detect if the optical mouse is using the second zone to navigate on the computer. The detector unit comprises a reflective layer 127 that operates together with one or more photo cells 126 (four photo cells are shown in the figure) to detect the light emitted from the optical mouse. The purpose of the reflective layer 127 is to convey the emitted light to any photo cell 126 to generate a signal from the mouse pad 125 to a control device 128 through a thinner and more flexible cable 129. The control unit, switch and cable connectors for cables 121 and 122 are provided in the control device 128.

FIG. 7 shows a computer system 130, identical to the computer system described in connection with FIG. 1 with the exception that a sixth embodiment of a control system 140 is used. The computer system comprises a computer 11, a computer display 12 with a web camera 13, a keyboard 14, and a pointing device 15, i.e. a computer mouse, adapted to navigate on the computer when the pointing device is moved across a tracking surface 145. The control system 140 is, in this embodiment designed as a mouse pad, provided with connectors in order to be connected between the network card of the computer 11 and the Internet 16 through cables 17 and 18. Access to the Internet is controlled by the control system 140 comprising an internal switch 141 which state is determined by the position of the pointing device 15 on the tracking surface 145 of the control system 140. The tracking surface 145 is in this embodiment divided into two zones, a first zone 142 and a second zone 143. The zones may be marked with different colours, e.g. red/green, or be divided by a line, as illustrated in the figure, to make the user aware of the different zones. The internal switch 1411 is preferably a semi-conductor device included in an integrated circuit.

A detection unit (not shown) and a control unit (not shown) are embedded in the control system 140. The detection unit detects when the pointing device 15 (mouse) is present in the first zone 142, and the control unit is configured to change the state of the internal switch 141, i.e. activate or deactivate, a function, which in this embodiment is to open/close access to Internet, when the pointing device is present in the first zone 142. No change in the state of the switch 141 is made when the pointing device is used in the second zone 143. The activation is preferably instantaneous, and the deactivation may be immediate but is preferably delayed a preselected period of time to avoid unintentional deactivation by moving the pointing device into the first zone for a short period of time.

The detection unit preferably comprises a detection layer (similar to the ones described in connection with FIGS. 3a-3d) based on magnetic detection comprising coils or permanent magnets. The mouse is configured to affect a magnetic field induced by the coils, or magnets, when moved across the first zone 142. An indication of a change in the magnetic field is detected and the control unit will activate the desired function if not active, and deactivate the function if active. The detection may naturally be based on capacitive detection, inductive detection, pressure detection, electromagnetic detection, optical detection, or ultrasound detection of the pointing device similar to that disclosed in connection with FIGS. 3a-3d above.

The control unit may further be configured to establish a communication link, preferably a secure communication link, to an external network, such as a restricted network of a company.

An indicator 144, such as a light emitting diode (LED) is preferably provided in the tracking surface 145, e.g. in the first zone 142, to make the user aware of if the function, e.g. Internet access, is activated or not.

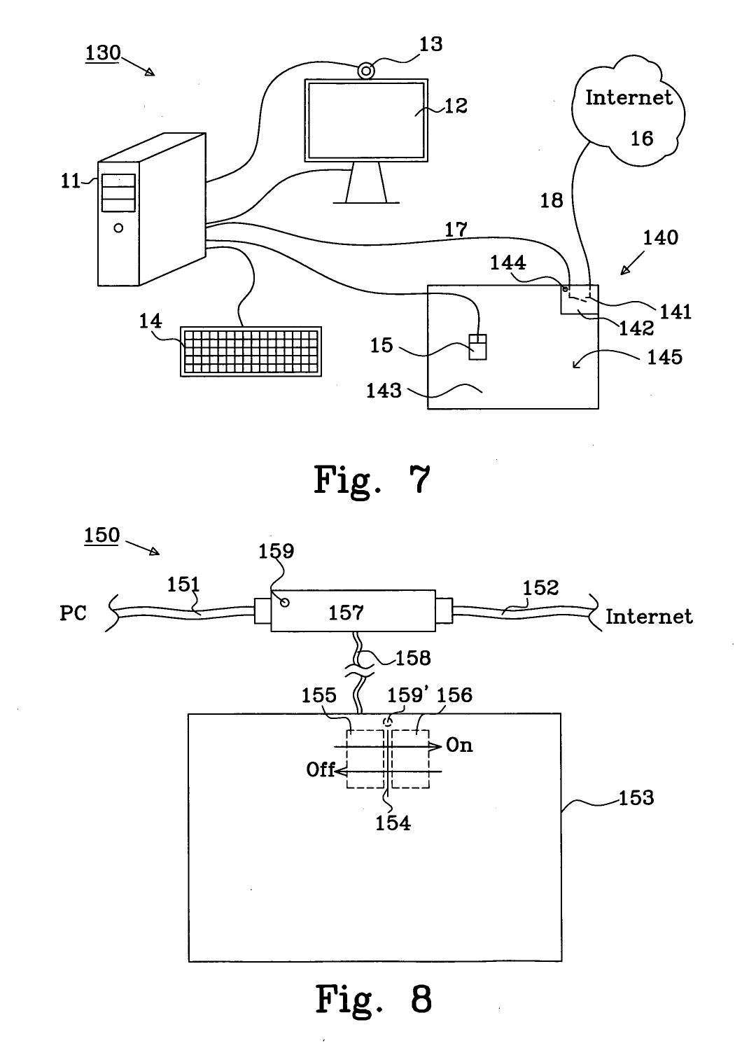

FIG. 8 shows a second embodiment of a control system 150 according to the present invention. The control system 150 is adapted to be connected to a computer (not shown) through a cable 151 and to Internet through cable 152. A tracking surface is provided on a mouse pad 153 and is provided with a line 154 dividing a part of the tracking surface 153 into a first zone 155 and a second zone 156. A pointing device (not shown), such as a mouse, is used to navigate on the computer when moved across the tracking surface 153. The detector unit comprises a means to detect the direction the mouse is moved across the line 154, i.e. from the first zone 155 to the second zone 156, or from the second zone 156 to the first zone 155. Detection may be based on magnetic detection, as illustrated above in connection with FIG. 7, or capacitive detection, inductive detection, pressure detection, electromagnetic detection, optical detection, or ultrasound detection of the pointing device similar to that disclosed in connection with FIGS. 3a-3d above.

Indication of the direction the mouse is moved across the line 154 is forwarded to a control device 157 through a thinner and more flexible cable 158. The control unit, switch and cable connectors for cables 151 and 152 are provided in the control device 157. Preferably an indicator 159 is included in the control device 157, or in the mouse pad 153 as indicated by the alternative position 159′ (if the user chooses to hide the control device 157), to make the user aware of the switching state (e.g. activated or not) for the desired function (e.g. access to Internet).

The invention should not be limited to the specific embodiments described above, since combinations of different features are readily available for a skilled person in the art.

1.-49. (canceled)

50. A system adapted to be connected to at least one computer provided with a pointing device, the system comprising:
at least one tracking surface, wherein the pointing device is adapted to navigate on the at least one computer when the pointing device is moved across the at least one tracking surface, and the at least one tracking surface defines a first zone and a second zone;
a detection unit which detects the zone the pointing device is present in; and
a control unit adapted to activate access to an external network when present in the first zone, wherein the control unit comprises an access device configured to connect/disconnect the computer to the external network in response to which zone the pointing device is present in.

51. The system of claim 50, wherein the control unit further is adapted to deactivate access to the external network when present in the second zone.

52. The system of claim 50, wherein the control unit further is adapted to change switching state of access to the external network when present in the first zone, and to maintain access to the external network when present in the second zone.

53. The system of claim 50, wherein the system comprises one tracking surface divided into the first zone and the second zone.

54. The system of claim 50, wherein the system comprises a first tracking surface defining the first zone, and a second tracking surface defining the second zone, the first and second tracking surfaces being separate.

55. The system of claim 54, wherein the first tracking surface is arranged on a top surface of the control unit and the second tracking surface is arranged on a reverse side, opposite to the top side, of the control unit.

56. The system of claim 54, wherein the first tracking surface is arranged side-by-side with the second tracking surface.

57. The system of claim 50, wherein the access device is configured to immediately disconnect the computer from the external network when access to the external network is deactivated, or to disconnect the computer from the external network after a preselected period of time when access to the external network is deactivated.

58. The system of claim 50, wherein the access to the external network is provided via Internet.

59. The system of claim 50, wherein the control unit further is configured to establish a secure communication link to the external network.

60. The system of claim 50, wherein the system is adapted to be connected to two computers, the control unit further is configured to activate switching between the two computers, and the control unit further comprises a switching device configured to connect the pointing device to a first computer to navigate on the first computer, or to a second computer to navigate on the second computer, in response to which zone the pointing device is present in.

61. The system of claim 60, wherein the system is adapted to be connected to a computer display, and the switching device further is configured to connect the computer display to the first computer, or to connect the computer display to the second computer, in response to which zone the pointing device is present in.

62. The system of claim 50, wherein the detection unit is based on magnetic detection, capacitive detection, or inductive detection, of a conductive object attached to the pointing device.

63. The system of claim 62, wherein the detection unit comprises a detection layer, arranged on the at least one tracking surface, connected to the control unit.

64. The system of claim 63, wherein the detection layer comprises at least one of conductive patches for capacitive detection, inductors for inductive detection, and means for detecting magnetic variations caused by the pointing device.

65. The system of claim 50, wherein the detection unit is based on pressure detection, electromagnetic detection, optical detection, or ultrasound detection of the pointing device.

66. The system of claim 65, wherein the detection unit further comprises a pressure sensitive layer arranged on the at least one tracking surface for pressure detection.

67. The system of claim 65, wherein the detection unit further comprises an antenna layer, arranged on the at least one tracking surface, connected to the control unit, the antenna layer being configured to detect an electromagnetic radiation emitted from the pointing device.

68. The system of claim 67, wherein the antenna layer is configured to detect changes in the electromagnetic field from the antenna by presence of the pointing device.

69. The system of claim 65, wherein the detection unit further comprises an ultrasound waveguide, arranged on the at least one tracking surface, connected to the control unit, the ultrasound waveguide being configured to detect the presence of the pointing device.

70. The system of claim 65, wherein the detection unit further comprises a reflective layer configured to convey light emitted from an optical mouse to one or more photo cells.

71. The system of claim 50, wherein the pointing device is a mouse and the at least one tracking surface is arranged in a mouse pad.

72. The system of claim 50, wherein the pointing device is a pointing pen.

73. The system of claim 72, wherein the at least one tracking surface is arranged on a touch-sensitive device.
